(19) United States
(12) Patent Application Publication
(10) Pub. No.: US 2002/0122076 A1
(43) Pub. Date: Sep. 5, 2002

(54) Automatic creation and deletion of shortcut icons

(75) Inventor: Tomoyuki Nakaki, Sapporo (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/087,848

(22) Filed: Mar. 5, 2002

(30) Foreign Application Priority Data
Mar. 5, 2001 (JP) 2001-060661

(51) Int. Cl. G09G 5/00

(52) U.S. Cl. 345/847

(57) ABSTRACT

When an application program is started up, a computer system automatically creates a shortcut icon to be used to start up the application program, and automatically deletes a shortcut icon that is determined to be no longer wanted. Upon startup of the application program, program startup information is created or updated, and when a prestored shortcut creation condition is satisfied, the shortcut icon for starting up the application program is created. The created shortcut icon for starting up the application program is deleted if the computer system determines, based on a prestored shortcut deletion condition and the program startup information, that the shortcut icon is no longer wanted.

### BACKGROUND OF THE INVENTION

1. Field of the Invention

The present invention relates to the automatic creation and deletion of shortcut icon files (hereinafter simply referred to as shortcuts) in a computer system, wherein a shortcut used to start up an application program is automatically created and a shortcut no longer wanted is automatically deleted.

2. Description of the Related Art

In an operating system for personal computers, such as Windows developed by Microsoft Corporation, an application program is started up by selecting the application from the Start menu created when the software was installed. Alternatively, the user may create a shortcut icon and place it on the Desktop or some other convenient location by associating the created shortcut icon with a specific application program so that the program can be easily launched by clicking the icon.

As an operating system is used over a long period of time, it is not rare for the operating system to become unstable, eventually necessitating the reinstallation of the operating system. Furthermore, with increasing capacity of hard disks, there has developed a need to provide large-capacity external storage devices to back up the entire disk. Generally, personal data can be saved on a magneto-optical storage device (MO) or the like, but the operating system, application programs, etc. need reinstalling.

In that case, since user created shortcuts are initialized, the user has had to re-create the shortcuts manually. If the user is to create a shortcut manually, the user himself must recognize the storage location of the application program to be associated with it. Also, there are not a few users who do not know how to create a shortcut.

An application program can be started up from the Start menu on which program installers automatically register the application programs, but since the menu is structured in multiple levels, it entails a cumbersome procedure requiring a number of steps to get to the desired application program. To avoid the trouble of going through such a procedure, it is common to create a shortcut on the Desktop for efficient operation.

However, shortcuts, once created, may often be left unused, and furthermore, many program installers automatically create a shortcut on the Desktop. This clutters the Desktop, and thus it may become necessary to clean up the Desktop. In addition, it is often the case that the user accidentally deletes a shortcut created on the Desktop; in this case also, the user has had to recreate the shortcut manually.

### SUMMARY OF THE INVENTION

To solve the above-outlined problems, it is an object of the present invention to provide a computer system that automatically creates a shortcut to an application program when the computer system determines it appropriate to create the shortcut, and that automatically deletes a shortcut no longer wanted and automatically restores a shortcut accidentally deleted by the user.

The present invention provides a method for automatically creating a shortcut icon file used to start up an application program, comprising the steps of: storing a condition for creating the shortcut icon file; updating an application program startup record in response to startup of the application program; and automatically creating the shortcut icon file for the application program when the startup record satisfies the creation condition.

The present invention also provides a method for automatically deleting a shortcut icon file used to start up an application program, comprising the steps of: storing a condition for deleting the shortcut icon file; updating an application program startup record in response to startup of the application program; and automatically creating the shortcut icon file for the application program when the startup record satisfies the deletion condition.

The present invention also provides an apparatus for automatically creating a shortcut icon file used to start up an application program, comprising: means for storing a condition for creating the shortcut icon file; means for updating an application program startup record in response to startup of the application program; and means for automatically creating the shortcut icon file for the application program when the startup record satisfies the creation condition.

The present invention also provides an apparatus for automatically deleting a shortcut icon file used to start up an application program, comprising: means for storing a condition for deleting the shortcut icon file; means for updating an application program startup record in response to startup of the application program; and means for automatically creating the shortcut icon file for the application program when the startup record satisfies the deletion condition.

Preferably, the creation condition includes the number of application program startups as a threshold value, and the startup record includes the number of application program startups.

Also, the deletion condition preferably includes as a threshold value a period during which the application program has not been executed, and the startup record includes a date at which the application program was executed.

### BRIEF DESCRIPTION OF THE DRAWINGS

FIG. 1 is a diagram showing the overall configuration of an embodiment according to the present invention;

FIG. 2 is a diagram showing a shortcut creation condition;

FIG. 3 is a diagram showing a shortcut deletion condition;

FIG. 4 is a diagram showing startup information stored for an application program;

FIG. 5 is a flowchart showing processing operations performed when a computer is powered up;

FIG. 6 is a flowchart showing processing operations performed when an application program is started up;

FIG. 7 is a flowchart showing a shortcut creation judging process;

FIG. 8 is a flowchart showing a process for storing program startup information pertaining to an application program;

FIG. 9 is a flowchart showing a shortcut creation process;

FIG. 10 is a flowchart showing a shortcut deletion judging process;

FIG. 11 is a flowchart showing a shortcut deletion process;

FIG. 12 is a flowchart showing a process for detecting an accidentally deleted shortcut; and

FIG. 13 is a diagram showing the relationship between a shortcut on the Desktop and a program file.

### DESCRIPTION OF THE PREFERRED EMBODIMENTS

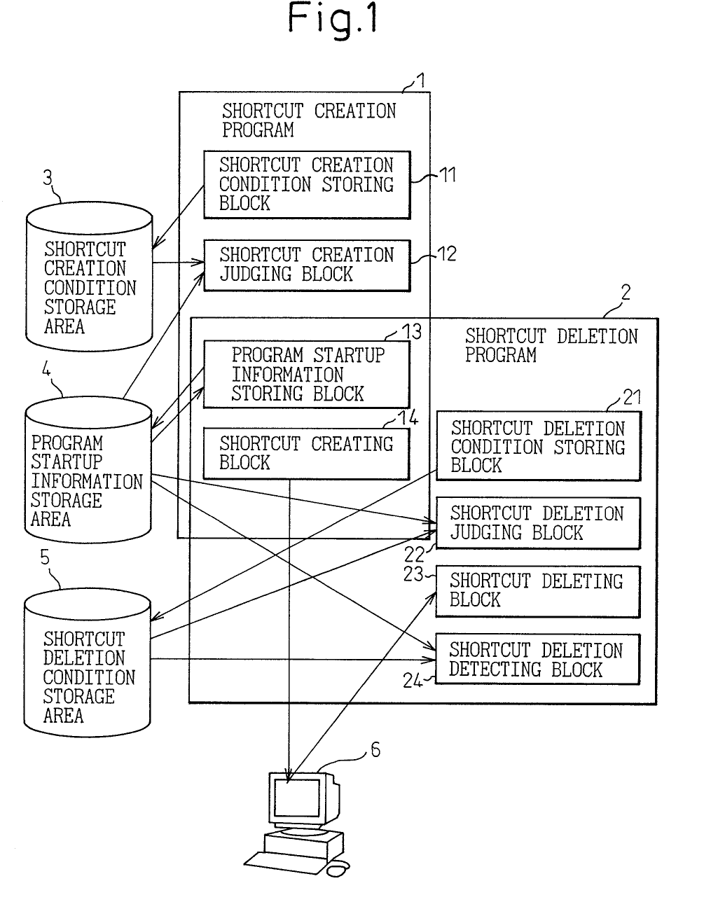

FIG. 1 is a diagram showing the overall configuration of an embodiment according to the present invention. The shortcut icon automatic creation/deletion program of the invention consists of a shortcut creation program 1 and a shortcut deletion program 2, and depending on system operation, a system configuration incorporating only the shortcut creation program 1 or the shortcut deletion program 2 is also possible. The shortcut creation program 1 and the shortcut deletion program 2 both are programs to which control is passed from an operating system when the computer is powered up, as well as when an application program is started up.

For techniques for passing control from the operating system at computer power-up or at the startup of an application program, use is made of such traditional techniques that register the programs in the Startup folder so that they are launched at Windows startup, or register programs to which control is passed when a specific event occurs.

The shortcut creation program 1 and the shortcut deletion program 2 are stored on a computer readable storing medium and, when started up, implement the following functional blocks.

The shortcut creation program 1 implements a shortcut creation condition storing block 11 which stores a user created and predefined shortcut creation condition in a shortcut creation condition storage area 3, a program startup information storing block 13 which, when an application program is started up, creates or updates program startup information pertaining to the application program within a program startup information storage area 4, a shortcut creation judging block 12 which judges whether a shortcut to the designated application program is to be created or not, based on the shortcut creation condition and on the program startup information created or updated by the program startup information storing block 13, and a shortcut creating block 14 which is invoked when it is judged by the shortcut creation judging block 12 that the creation of a shortcut is necessary, and which retrieves from the program startup information storage area 4 the information necessary for the creation of the shortcut to the designated application program and creates a shortcut icon file in a specified directory (puts the shortcut on the Desktop).

The shortcut deletion program 2 implements a shortcut deletion condition storing block 21 which stores a user created and predefined shortcut deletion condition in a shortcut deletion condition storage area 5, the program startup information storing block 13 which, when an application program is started up, creates or updates program startup information pertaining to the application program within the program startup information storage area 3, a shortcut deletion judging block 22 which judges whether there is a shortcut to be deleted, based on the shortcut deletion condition and on the program startup information created or updated by the program startup information storing block 13, and a shortcut deleting block 23 which is invoked when it is judged by the shortcut deletion judging block 22 that the deletion of a shortcut is necessary, and which deletes the shortcut to the designated application program, while also deleting the program startup information for that application program from the program startup information storage area 4.

Preferably, the shortcut creation judging block 13 of the shortcut creation program is activated when an application program is started up, and the shortcut deletion judging block 22 of the shortcut deletion program 2 is activated when the computer is powered up. Alternatively, they may be activated at another timing such as a specific date and time by using an API (Application Program Interface) of the operating system.

Furthermore, in order that a shortcut accidentally deleted by the user can be restored at the time of computer power-up, etc. the shortcut creation program 1 or the shortcut deletion program 2 may further include, in addition to the shortcut creating block 14 described in the section of the shortcut creation program, a shortcut deletion detecting block 24 that detects the accidentally deleted shortcut by referring to the shortcut information on the Desktop via the API and by using the shortcut deletion condition and the program startup information. The configuration of FIG. 1 shows an example in which the shortcut deletion detecting block 24 is included in the shortcut deletion program 2.

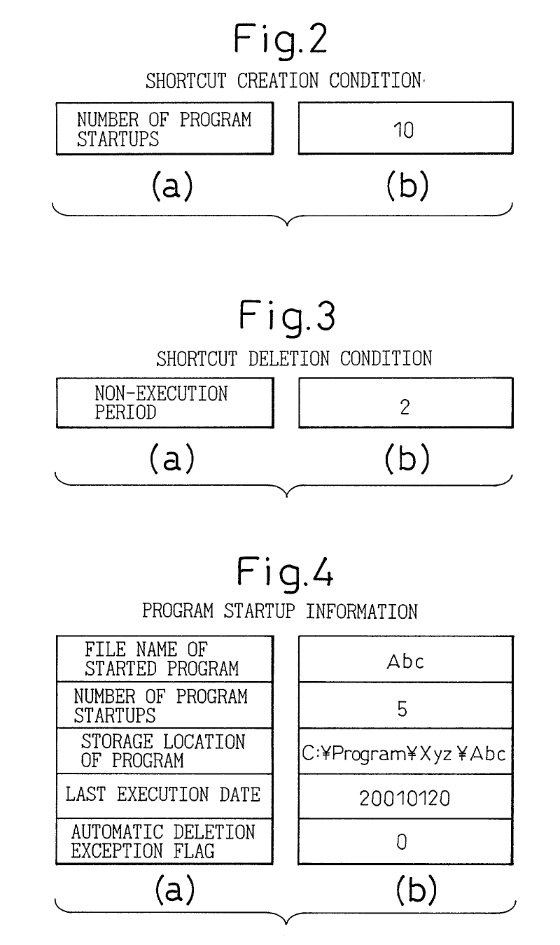

A user predefined shortcut creation condition such as shown in FIG. 2 is stored in the shortcut creation condition storage area 3. FIG. 2(a) shows that the number of program startups is predefined, and FIG. 2(b) shows an example of the predefined value. This example shows that when an application program is started 10 times, a shortcut to the application program is created. The shortcut creation condition can also be defined by combining the number of program startups with the period in various ways, for example, the condition may be defined to provide that a shortcut be created when the program is started 10 times in one day or in one month.

A user predefined shortcut deletion condition such as shown in FIG. 3 is stored in the shortcut deletion condition storage area 5. FIG. 3(a) shows that a nonexecution period during which an application program has not been executed is predefined, and FIG. 3(b) shows an example of the predefined value. This example shows that a shortcut to an application that has not been executed in two months is to be deleted. The shortcut deletion condition can also be defined by combining the number of program startups with the period in various ways, for example, the condition may be defined to provide that a shortcut be deleted if the program associated with it has not been started more than two times in one month.

Program startup information such as shown in FIG. 4 necessary for the maintenance and management of a shortcut to an application program is stored in the program startup information storage area 4. FIG. 4(b) shows predefined values by way of example. In the example shown, the program name and storage location of application program Abc, which become necessary when requesting creation or deletion of a shortcut using an API, and the number of program startups and the last execution date, based on which the shortcut is created or deleted, are stored in the program startup information storage area 4. An automatic deletion exception flag is a flag which can be set ON for an application program that is supposed to be executed, for example, once every six months, and therefore should not be deleted indiscriminately in accordance with the shortcut deletion condition.

Shortcuts created by the shortcut creation program and program installers are displayed on a display of the computer 6. Of the shortcuts displayed on the computer display, those that are determined no longer wanted are deleted by the shortcut deletion program.

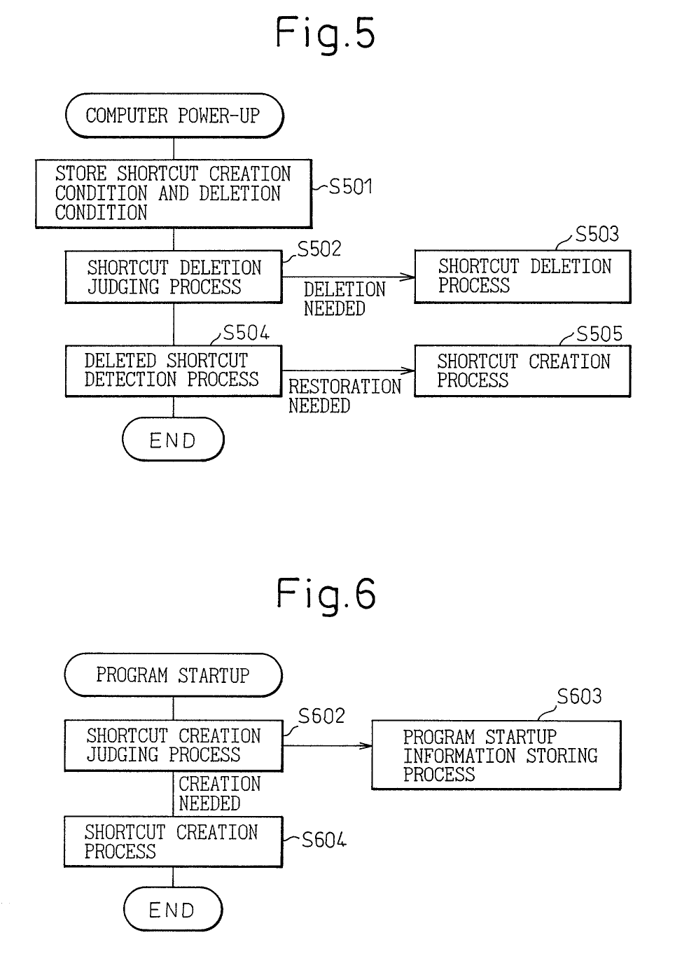

FIGS. 5 to 12 show process flows according to the present invention. In the embodiment shown here, the program startup information storing block 13 is shared between the shortcut creation program 1 and the shortcut deletion program 2. To implement the function of restoring an accidentally deleted shortcut, the shortcut deletion detecting block 24 is incorporated in the shortcut deletion program 2, and the shortcut creating block 14 is shared with the shortcut creation program 1. The shortcut creation program 1 and the shortcut deletion program 2 both are programs to which the operating system passes control when the computer is powered up, as well as when an application program is started up.

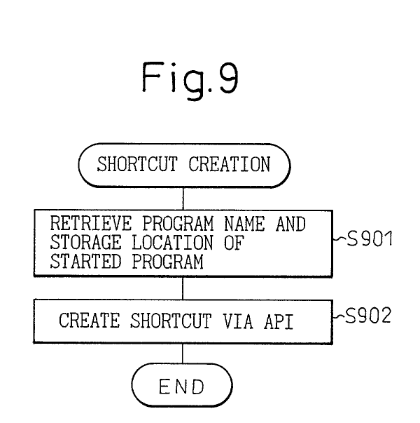

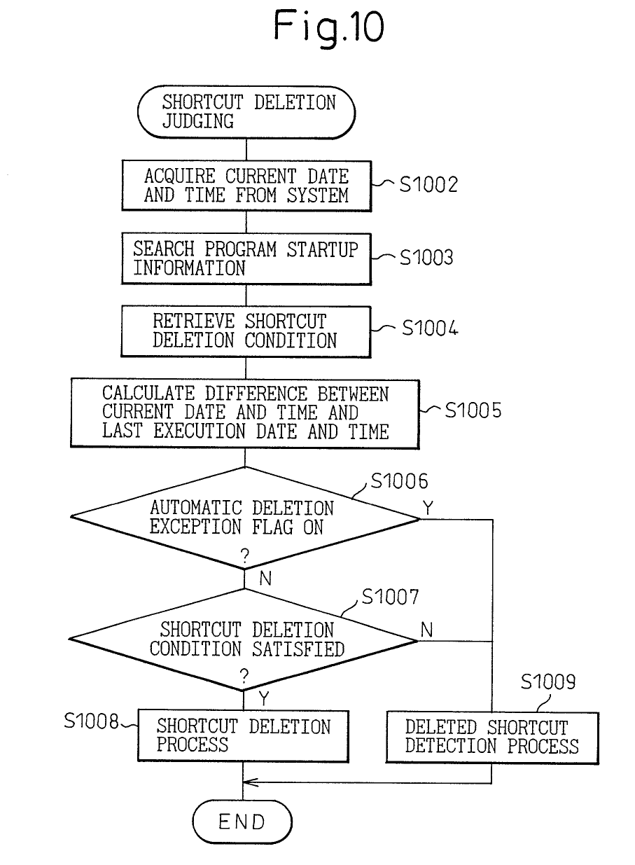

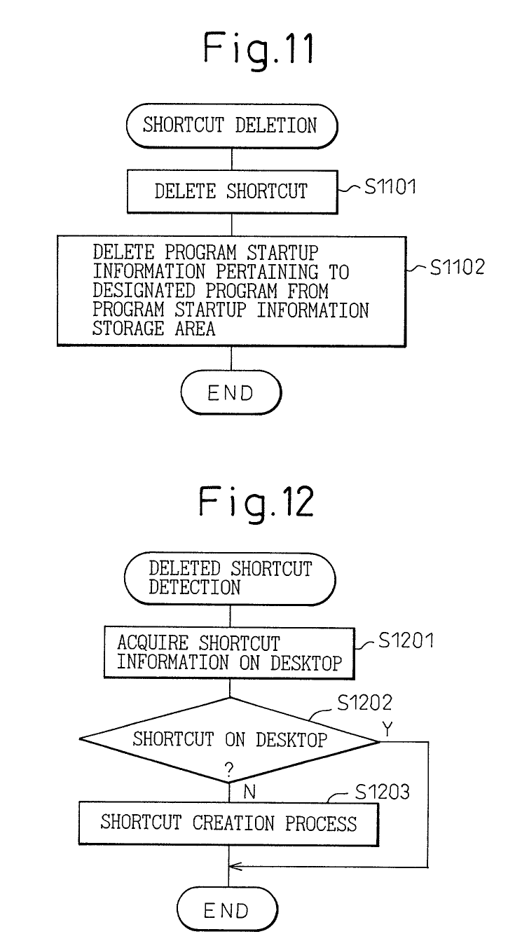

FIG. 5 shows processing operations performed when the computer is powered up. When the computer 6 is powered up, the shortcut creation program 1 and the shortcut deletion program 2, both registered in the Startup, are started up. When the shortcut creation program 1 and the shortcut deletion program 2 are started up, the shortcut creation condition storing block 11 and the shortcut deletion condition storing block 21 are invoked, and the user predefined shortcut creation condition and shortcut deletion condition are stored in the shortcut creation condition storage area 3 and the shortcut deletion condition storage area 5, respectively (S501). The processing by the shortcut creation program 1 is terminated here, but the shortcut deletion program 2 proceeds to invoke the shortcut deletion judging process shown in FIG. 10 in order to delete a shortcut no longer wanted (S502). If there is a shortcut no longer wanted, the shortcut deletion process shown in FIG. 11 is invoked to delete the shortcut (S503). Further, the deleted shortcut detection process shown in FIG. 12 is invoked to detect whether there is a shortcut accidentally deleted by the user (S504). If a shortcut accidentally deleted by the user is detected, the shortcut creation process shown in FIG. 9 is invoked in order to restore the shortcut (S505).

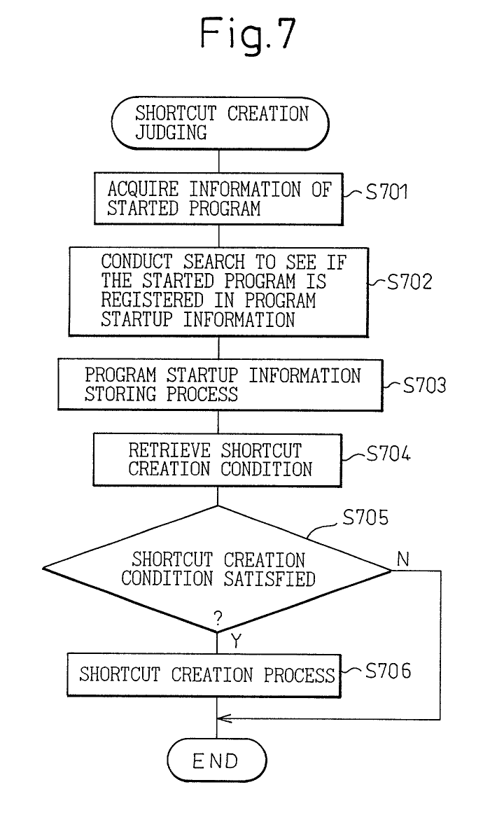

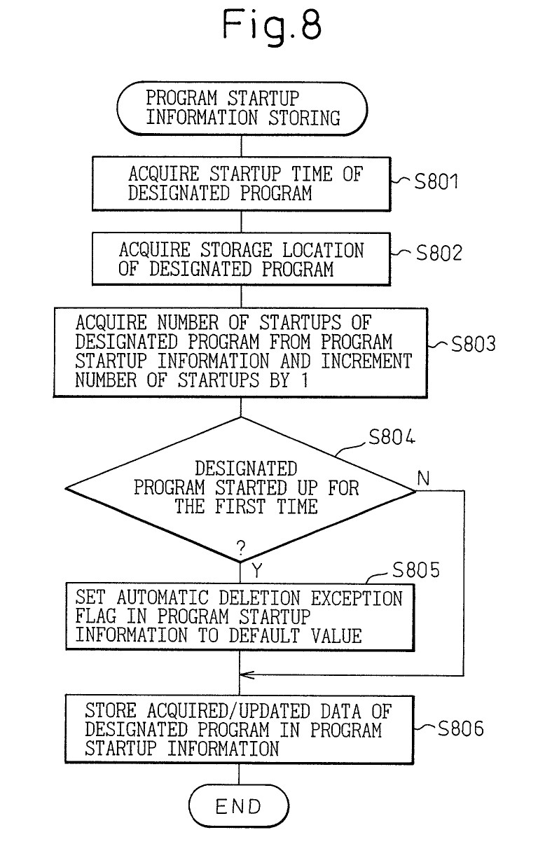

FIG. 6 shows processing operations performed when an application program is started up. When an application program is started up, the shortcut creation program is started up via the API if the shortcut creation program is installed, but if only the shortcut deletion program is installed, the shortcut deletion program is started up. In the present embodiment, since both programs are installed, the shortcut creation program is started up. The shortcut creation judging process shown in FIG. 7 is invoked to determine whether it is necessary to create a shortcut to the application program (S602), and further, the program startup information storing process shown in FIG. 8 is invoked to create or update program startup information (S603). If it is determined that the creation of a shortcut is necessary, the shortcut creation process shown in FIG. 9 is invoked (S604). On the other hand, when only the shortcut deletion program is installed, the program startup information storing block of the shortcut deletion program 2 is activated to create or update program startup information, but the process will not be described here, since it is the same as the process performed by the shortcut creation program.

FIG. 7 shows the shortcut creation judging process. First, the file name of the started application program is acquired via the API (S701). Using the acquired file name as the key, the program startup information storage area 4 is searched for the program startup information pertaining to the designated application program. If the application program is started for the first time, and therefore program startup information is not created yet, program startup information for that application program is created (S702). Then, the program startup information storing process shown in FIG. 8 is invoked (S703). Next, the shortcut creation condition is retrieved from the shortcut creation condition storage area 3 (S704), and it is determined whether the shortcut creation condition is satisfied by referring to the program startup information retrieved from the program startup information storage area 4 for the application program (S705). If the creation of a shortcut is necessary, the shortcut creation process shown in FIG. 9 is invoked (S706).

FIG. 8 shows the program startup information storing process. The current time and the storage location of the designated application program are acquired via the API to store the startup time of the application program (S801, S802). The number of startups is acquired from the program startup information pertaining to the application program, and is incremented by 1 (S803). It is checked whether the application program has been started for the first time (S804). If it has been started for the first time, the automatic deletion exception flag in the program startup information is set to the default value (S805). The default value is usually OFF indicating that the shortcut to the application program is automatically deletable. However, there are application programs whose shortcuts should not be deleted automatically; in that case, if provisions are made to be able to change the value of the automatic deletion exception flag, the designated application program can be excluded from the automatic shortcut deletion list. This can be accomplished, for example, by allowing the user to predefine the application program that should be excluded from the list, or to decide or dynamically specify, using a command, whether the application program is to be included in the list, through a dialog when creating the shortcut to the application program for the first time. The shortcut management information thus set up for the application program is updated on the program startup information storage area 4 (S806).

FIG. 9 shows the shortcut creation process. The program name and the storage location of the designated application program are retrieved as shortcut creation request parameters from the program startup information storage area 4 (S901). A shortcut creation request is made via the API (S902).

FIG. 10 shows the shortcut deletion judging process. When the computer is powered up, the shortcut deletion program 2 registered in the Startup is started up, and the shortcut deletion judging process is invoked as explained with reference to FIG. 5. In the shortcut deletion judging process, the current date and time is acquired via the API (S1002). This is the step necessary to obtain the difference between the last execution date and time and the current date and time, because it is assumed here that the non-execution period is specified as the deletion condition. The program startup information storage area 4 is searched to retrieve the program startup information for the designated application program (S1003), and further, the shortcut deletion condition is retrieved from the shortcut deletion condition storage area 5 (S1004). The difference between the current date and time and the last execution date and time is calculated (SlOO5). The automatic deletion exception flag is checked to see if the application program is one whose shortcut is automatically deletable (S1006). If the automatic deletion exception flag is ON, the shortcut deletion process is not performed. In the present embodiment, since provisions are made so that the shortcut, if accidentally deleted by the user, can be restored, the deleted shortcut detection process shown in FIG. 12 is invoked (S1009). On the other hand, if the automatic deletion exception flag is OFF, it is checked whether the period obtained in S1005 exceeds the non-execution period specified as the deletion condition in order to determine whether the deletion condition is satisfied (S1007). If the period does not exceed the specified period, the deleted shortcut detection process is invoked as in the case of S1006 (S1009). If the period exceeds the specified period, the shortcut deletion process shown in FIG. 11 is invoked to automatically delete the shortcut (S1008). The process from S1006 to S1009 is performed on all the application programs whose information is stored in the program startup information storage area 4.

FIG. 11 shows the shortcut deletion process. A shortcut deletion request is made via the API (S1101). The program startup information pertaining to the designated application program is deleted from the program information storage area 4 (S1102).

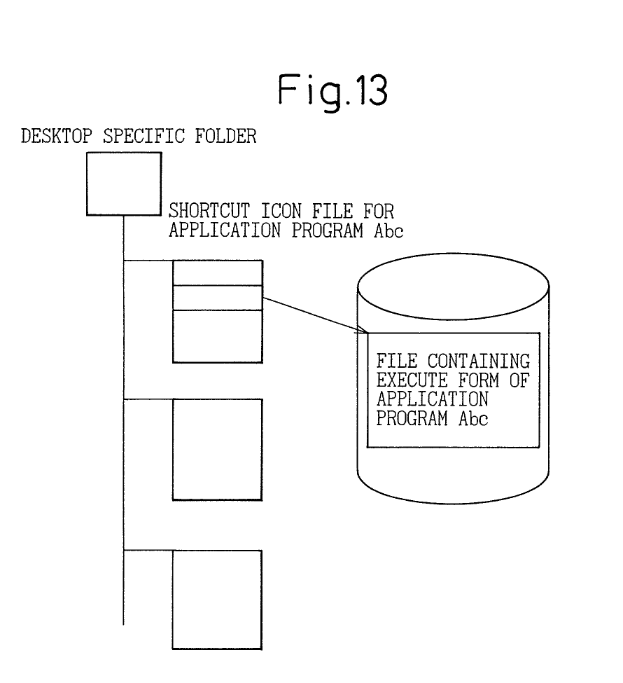

FIG. 13 shows the relationship between a shortcut on the Desktop and the application program file associated with it. When a shortcut icon file containing shortcut control information is created in a designated Desktop specific folder, the corresponding shortcut icon is placed on the Desktop by the operating system. A file containing the execute form of the application program executable by clicking the shortcut icon is linked to the shortcut icon file. Accordingly, for any particular application program, when the program storage location registered in the program startup information and the program storage location registered in the shortcut icon file are searched for and compared with each other, if the shortcut icon associated with the application program is not found when the application program does not satisfy the shortcut deletion condition defined in the program startup information, then it can be determined that the shortcut for that application program has been deleted accidentally by the user.

FIG. 12 shows the process for detecting a shortcut accidentally deleted by the user. The shortcut information on the Desktop is acquired via the API (S1201). For every application program whose information is stored in the program startup information storage area 4, the program startup information pertaining to the application program and the shortcut deletion condition are examined to check whether a shortcut supposed to exist does exist on the Desktop (S1202). If the shortcut supposed to exist does not exist on the Desktop, it is determined that the shortcut has been deleted accidentally by the user, and the shortcut creation process shown in FIG. 9 is invoked by acquiring the shortcut creation request parameters from the program startup information (S1203).

As described above, the present invention offers the following advantageous effects:

1. In the present invention, since the computer system automatically creates a shortcut when a prescribed condition is satisfied at the startup of an application program, even those users who are not familiar with computers or do not have enough knowledge about computers can use shortcuts, and the usability of the computer can thus be enhanced.

2. In the present invention, since a shortcut that satisfies a prescribed condition preset by the user (a shortcut no longer wanted) is automatically deleted by the computer system, only necessary shortcuts can be left on the Desktop without having to manage (clean up) the shortcuts on the Desktop. This makes it easier to select the desired shortcut and enhances the usability of the computer.

3. In the present invention, the program startup information is managed and updated by the computer system so that a shortcut that is deleted but does not satisfy the specified deletion condition can be automatically restored. As a result, if the user has accidentally deleted a shortcut, the user does not have to go to the trouble of re-creating the shortcut, and the usability of the computer can thus be enhanced.

1. A method for automatically creating a shortcut icon file used to start up an application program, comprising the steps of:
storing a condition for creating the shortcut icon file;
updating an application program startup record in response to startup of the application program; and
automatically creating the shortcut icon file for the application program when the startup record satisfies the creation condition.

2. A method according to claim 1, wherein the creation condition includes the number of application program startups as a threshold value, and
the startup record includes the number of application program startups.

3. A method according to claim 1, further comprising the steps of:
storing a condition for deleting the shortcut icon file; and
automatically deleting the shortcut icon file for the application program when the startup record satisfies the deletion condition.

4. A method according to claim 3, wherein the deletion condition includes as a threshold value a period during which the application program has not been executed, and
the startup record includes a date at which the application program was executed.

5. A method for automatically deleting a shortcut icon file used to start up an application program, comprising the steps of:
storing a condition for deleting the shortcut icon file;
updating an application program startup record in response to startup of the application program; and
automatically deleting the shortcut icon file for the application program when the startup record satisfies the deletion condition.

6. A method according to claim 5, wherein the deletion condition includes as a threshold value a period during which the application program has not been executed, and
the startup record includes a date at which the application program was executed.

7. A method according to claim 5, further including the step of restoring the shortcut icon file for the application program when the startup record of the application program does not satisfy the deletion condition and when the shortcut icon file corresponding to the application program is not found.

8. An apparatus for automatically creating a shortcut icon file used to start up an application program, comprising:
means for storing a condition for creating the shortcut icon file;
means for updating an application program startup record in response to startup of the application program; and
means for automatically creating the shortcut icon file for the application program when the startup record satisfies the creation condition.

9. An apparatus according to claim 8, wherein the creation condition includes the number of application program startups as a threshold value, and
the startup record includes the number of application program startups.

10. An apparatus according to claim 8, further comprising:
means for storing a condition for deleting the shortcut icon file; and
means for automatically deleting the shortcut icon file for the application program when the startup record satisfies the deletion condition.

11. An apparatus according to claim 10, wherein the deletion condition includes as a threshold value a period during which the application program has not been executed, and
the startup record includes a date at which the application program was executed.

12. An apparatus for automatically deleting a shortcut icon file used to start up an application program, comprising:
means for storing a condition for deleting the shortcut icon file;
means for updating an application program startup record in response to startup of the application program; and
means for automatically deleting the shortcut icon file for the application program when the startup record satisfies the deletion condition.

13. An apparatus according to claim 12, wherein the deletion condition includes as a threshold value a period during which the application program has not been executed, and
the startup record includes a date at which the application program was executed.

14. An apparatus according to claim 12, further including means for restoring the shortcut icon file for the application program when the startup record of the application program does not satisfy the deletion condition and when the shortcut icon file corresponding to the application program is not found.

15. A program storage device readable by a machine, tangibly embodying a program of instructions executable by the machine to perform method steps for creating a shortcut icon file used to start up an application program, said method steps comprising:
storing a condition for creating the shortcut icon file;
updating an application program startup record in response to startup of the application program; and
automatically creating the shortcut icon file for the application program when the startup record satisfies the creation condition.

16. A program storage device according to claim 15, wherein the creation condition includes the number of application program startups as a threshold value, and
the startup record includes the number of application program startups.

17. A program storage device according to claim 15, further comprising the steps of:
storing a condition for deleting the shortcut icon file; and
automatically deleting the shortcut icon file for the application program when the startup record satisfies the deletion condition.

18. A program storage device according to claim 17, wherein the deletion condition includes as a threshold value a period during which the application program has not been executed, and
the startup record includes a date at which the application program was executed.

19. A program storage device readable by a machine, tangibly embodying a program of instructions executable by the machine to perform method steps for deleting a shortcut icon file used to start up an application program, said method steps comprising:
storing a condition for deleting the shortcut icon file;
updating an application program startup record in response to startup of the application program; and
automatically deleting the shortcut icon file for the application program when the startup record satisfies the deletion condition.

20. A program storage device according to claim 19, wherein the deletion condition includes as a threshold value a period during which the application program has not been executed, and
the startup record includes a date at which the application program was executed.

21. A program storage device according to claim 19, further comprising the step of restoring the shortcut icon file for the application program when the startup record of the application program does not satisfy the deletion condition and when the shortcut icon file corresponding to the application program is not found.
